(19) United States
(12) Patent Application Publication
(10) Pub. No.: US 2012/0178043 A1
(43) Pub. Date: Jul. 12, 2012

(54) SURGICAL DRILLS

(76) Inventor: Jerome Haber, Weston, MA (US)

(21) Appl. No.: 13/348,046

(22) Filed: Jan. 11, 2012

Related U.S. Application Data
(60) Provisional application No. 61/431,702, filed on Jan. 11, 2011.

(51) Int. Cl. A61C 3/02

(52) U.S. Cl. 433/75; 433/165

(57) ABSTRACT

A series of drills are provided for creating progressively larger and/or deeper holes in a dental implant procedure based upon a single drill guide. In one embodiment, the drills are monolithic or single-piece drills. In another embodiment, drills are held in drill extensions that provide control of depth independent of drill length. Using the techniques described herein, a kit of drills and/or extensions may be provided for independent control of hole depth and hole diameter during a progressive drilling procedure.

### RELATED APPLICATIONS

This application claims priority to U.S. Prov. App. No. 61/431,702, filed on Jan. 11, 2011, which application is incorporated by reference herein in its entirety.

### BACKGROUND

The invention relates to drills and drill extensions for use in dental implant surgery and similarly constrained surgical and/or drilling operations.

Drill guides are commonly used by dental surgeons to impose a predetermined trajectory on a drill to create a hole for a dental implant. Because a series of drills of increasing diameters are generally used to create a final hole, multiple drill guides with guide tubes or holes of similarly increasing diameter are typically required. One alternative to multiple drill guides is the use of special inserts or keys corresponding to changing drill diameters. Both of these approaches are cumbersome and inefficient.

Depth stops are commonly used by dental surgeons to limit the depth to which a drill can penetrate the jaw bone to create a hole for a dental implant. The depth stop is a cylinder with a larger diameter than the cutting portion of a drill and placed on a drill at a point where the portion of the drill extending from the drill stop equals the desired depth of the hole to be drilled. Depth stops only work as intended if the bone surface is flat and the drill is used perpendicular to the bone surface. If the bone surface is irregular or the drill is angled to the bone surface, the drill stop will prevent the drill from penetrating to its full length and resulting hole will be shallower than intended. Since the jaw surface is often irregular and implant drills are usually used at an angle to the jaw surface, the limitations of drill stops preclude their use in most cases.

There remains a need for improved implant drills and drill stops for use with a single drill guide(s) in dental surgery and similarly constrained surgical and/or drilling operations.

### SUMMARY

A series of drills are provided for creating progressively larger and/or deeper holes in a dental implant procedure based upon a single drill guide. In one embodiment, the drills are monolithic or single-piece drills. In another embodiment, drills are held in drill extensions that provide control of depth independent of drill length. Using the techniques described herein, a kit of drills and/or extensions may be provided for independent control of hole depth and hole diameter during a progressive drilling procedure.

In one aspect, a kit disclosed herein includes: a first drill having a top, a middle, and a bottom, wherein the top may be shaped and sized to be placed and secured in a drill chuck, the middle may have a circular cross section with a diameter matched to a guide hole in a surgical guide and a bottom surface proximal to the bottom that serves as a drill stop to limit drilling depth, and the bottom extends from the middle to an end, the bottom having a second circular cross section with a second diameter smaller than the diameter of the middle and a length from the middle to the end selected according to a hole depth for the first drill, the bottom further including one or more cutting surfaces; and a second drill having a second top, a second middle, and a second bottom, wherein the second top may be shaped and sized to be placed and secured in the drill chuck, the second middle may have a third circular cross section with a third diameter matched to the guide hole in the surgical guide, and the second bottom may have a fourth diameter equal to the second middle and a depth guide providing a visible indicator of drill depth.

The bottom surface of the first drill may include an end cutting burr to remove interfering bone. The kit may further include a plurality of additional drills each having an additional top shaped and sized to be placed and secured in the chuck and an additional middle with a circumference matched to the guide hole, each one of the plurality of additional drills configured for a different hole diameter or a different hole depth from the first drill and the second drill.

The depth guide may include a visible mark at a predetermined location on an exterior of the second drill. The depth guide may include a laser line etched on an exterior of the second drill. The kit may further include sterile packaging for each of the first drill and the second drill. The drilling procedure may be a surgical drilling procedure or a dental drilling procedure.

In another aspect, a kit disclosed herein includes: a plurality of drills having cutting portions with various cutting diameters and shafts having equal lengths and cross sections keyed for rotationally secure engagement in a corresponding hole; and a plurality of drill extensions each having an end fitted to a drill chuck, an equal exterior diameter, and an interior bore shaped to secure each one of the plurality of drills in rotationally secure engagement, wherein the interior bore of each one of the plurality of drill extensions may have a different depth.

The plurality of drills may be color coded to identify the cutting diameter and/or the drill depth. The drilling procedure may be a dental drilling procedure or a surgical drilling procedure.

In another aspect, a kit disclosed herein includes: a plurality of drills having equal lengths and having cutting portions with various cutting diameters, each one of the plurality of drills having a top section keyed for secure rotational engagement in a hole; a plurality of drill extensions each having a top and a bottom, wherein the top may be shaped and sized to be placed and secured in a drill chuck and the bottom may have a circular cross section with a diameter matched to a guide hole in a surgical guide, the bottom including a bottom surface proximal to the bottom that serves as an end cutting burr to remove interfering bone, each one of the plurality of drill extensions further including an interior bore shaped to secure the top section of each one of the plurality of drills in a rotationally secure engagement, wherein the interior bore of each one of the plurality of drill extensions may have a different depth.

Each one of the plurality of drills may include a visual code to identify the cutting diameter and/or to identify drill depth. The visual code may be at least one of a visible marking and a color. The drilling procedure may be a dental drilling procedure or a surgical drilling procedure.

### DRAWINGS

The invention and the following detailed description of certain embodiments thereof may be understood by reference to the following figures, where like element numbers refer to like features. The drawings are provided by way of illustration and not limitation, and the disclosed features are not necessarily drawn to scale:

FIG. 1 shows a surgical drill guide for dental applications.

FIG. 2 shows a surgical drill guide for dental applications.

FIG. 3 shows a set of implant drills.

FIG. 4 shows a set of implant drills in use with a drill guide.

FIG. 5 shows a set of drill extensions.

FIG. 6 shows a set of drills for use with a drill extension.

FIG. 7 shows an end cutting feature of a drill.

FIG. 8 shows an end cutting feature of a drill in use with a drill guide.

### DESCRIPTION

Disclosed herein is a surgical drill for use with a drill guide, wherein the mid-portion of the drill corresponds to the diameter of a guide hole in a surgical guide, regardless of the diameter of the cutting portion of the drill. A series of such drills with increasing cutting portion diameters can be used with a single drill guide to create a hole for a dental implant, eliminating the need for multiple drill guides or special inserts (or keys) corresponding to changing drill diameters. In general, the diameter of a cutting portion of each drill is less than or equal to the diameter of the mid-portion. It is noted that the term “guide hole” refers to a hole or guide tube in a drill guide such as any of the drill guides described in U.S. patent application Ser. No. 12/816,710, filed on Jun. 16, 2010 and incorporated by reference herein in its entirety, or any other guide for surgical drilling procedures such as tube guides that use an elongated sleeve of stainless steel or the like.

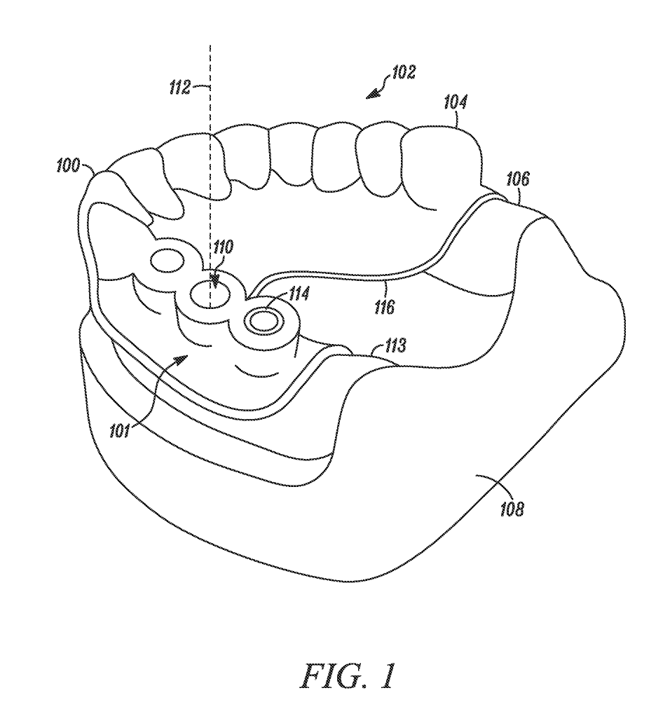

FIG. 1 shows an example of a device 100 including a surgical guide 101 and a support 102 that may be used with the present surgical drill. In general, the surgical guide 101, which may be a surgical drill guide for use in dental procedures or the like, may include one or more holes 110 to align a drill with an axial trajectory 112. The support 102 may be fitted to the teeth 104, soft tissue 106, and/or bone 108 in order to retain the surgical guide 101 relatively immobile with respect to the bone 108 during a drilling operation. It will be understood that while terms such as “surgical guide” or “drill guide” are typically used in the art to describe the entire device 100 depicted in FIG. 1, the following description refers periodically to a “surgical guide” instead as that portion of such a device 100 that physically retains a drill or other tool or object along the axial trajectory 112 in order to distinguish this functional portion from the support 102, which operates to secure the surgical guide 101 (and the axial trajectory 112 defined by same) relative to a target location. Thus depending on the context a “surgical guide” as used herein may refer specifically to a portion of a device that has one or more holes (or other guiding elements), or may refer generally to an entire device that is used as a drill guide or the like.

In general, the support 102 secures the surgical guide 101 in relation to a location where the axial trajectory 112 meets a target surface 113. The support 102 may provide tooth support, soft tissue support, and/or bone support. As depicted, the support 102 may include a surface 116 (the interior surface of the device 100) formed to dentition around a dental implant site, thus providing tooth support.

While not visible in FIG. 1, it will be appreciated that the target surface 113 extends to a location beneath the surgical guide 101 where the axial trajectory 112 intersects the soft tissue 106 or bone 108 so that a drill or other tool may be directed into the jaw at an appropriate location and orientation. As used herein, the term “target surface” is generally intended to refer to an exterior, two-dimensional surface of a surgical site that includes a location where a drill, tool, or implant is intended to enter the surgical site, unless a different meaning is specifically provided or otherwise clear from the context. In general, the target surface follows surface contours of a dental arch that is prepared for surgery and includes a single point of intersection with the axial trajectory 112. The target surface 113 may include any soft tissue 106 or bone 108 as described herein.

One or more holes 110 may be provided within the surgical guide 101 that are shaped, sized, and oriented to align a drill, hand cutting tool, or other tool or item with the axial trajectory 112. While three holes 110 are depicted, it will be understood that the surgical guide 101 may include fewer or more holes. Thus for example, the surgical guide 101 may include one hole, two holes, three holes, four holes, or any other suitable number of holes, such as for multiple implants that are planned for a patient using the device 100. It will also be appreciated that each hole 110 may include a sleeve 114 therein that protects the surgical guide 101 against a cutting edge of a drill or other tool. The sleeve 114 may be formed of a steel, a titanium, a glass, a plastic, an aluminum, or any other material or combination of materials suitably hardened to resist cutting or abrasion from a cutting tool such as a drill.

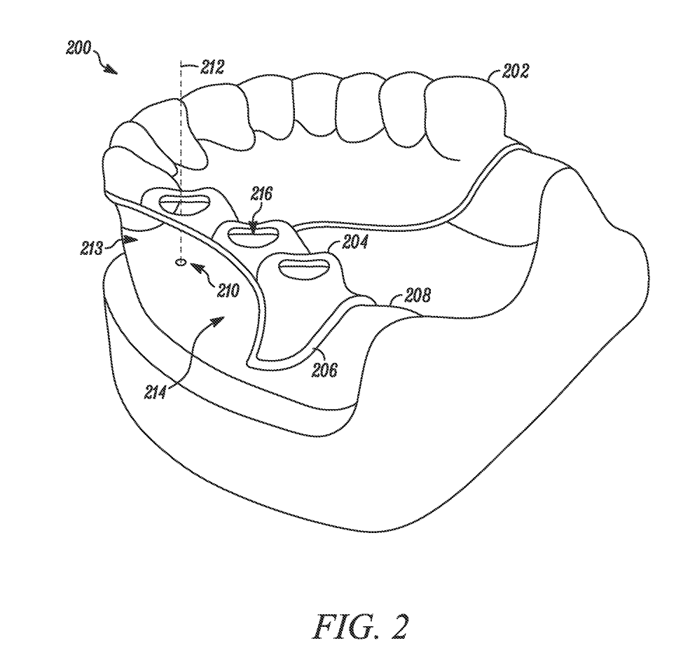

FIG. 2 shows another example of a device 200 including a support 202 and a surgical guide 204 that may be used with the present drill. A layer 206 of material that forms the surgical guide 204 may be spaced apart from a target surface 208 in an area 210 where an axial trajectory 212 intersects the target surface 208, which area 210 may include any surrounding surfaces and/or volume. The layer 206 may be of any shape or size consistent with adequate support of the surgical guide 204 in a manner to retain a drill or other tool as described herein. In one aspect, the separation of the layer 206 from the target surface 208 provides an interior space 213 around the axial trajectory 212 including a working volume that permits an insertion of a tool off-axis from the axial trajectory 212. In addition, the layer 206 may be shaped to include a window 214 with an opening for physical access to the space between the layer 206 and the target surface 208. This window 214 may be used for access by a surgeon to the target surface 208 for cleaning, inspection, irrigation, suction, material or tool removal, or any other purpose. The window 214 may also or instead provide an opening for visual inspection of the target surface 208 while the surgical guide 204 is in use (e.g., with a drill inserted into one of the holes in the surgical guide 204). The window 214 may include an opening for visual inspection along some or all of the axial trajectory 212 in the space between the target surface 208 and the layer 206 of material. It will be understood that the window 214 or portions thereof may be formed of a clear material that provides visual access into areas enclosed by the surgical guide 204 and/or the support 202 without affording physical access.

A hole 216 in the surgical guide 204 can serve to guide or otherwise retain a tool (not shown) at a point above or otherwise separated from the target surface 208.

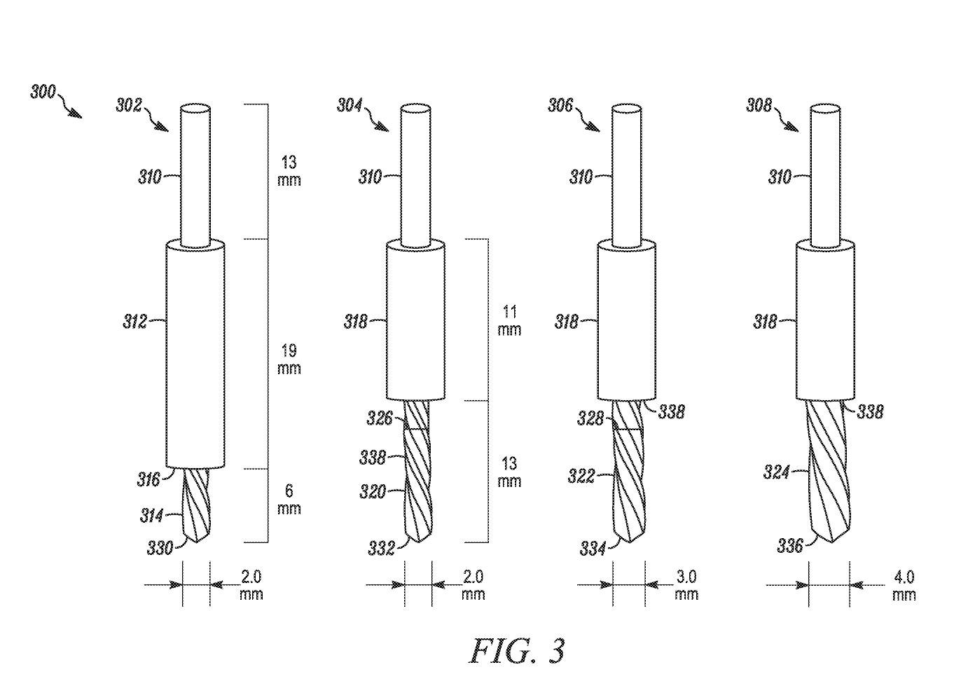

FIG. 3 shows a kit 300 or set of four implant drills 302, 304, 306, 308 of increasing diameter for use in a surgical or dental drilling procedure. Each drill 302, 304, 306, 308 may have a top or upper section 310, a middle 312, 318 and a bottom or cutting portion 314, 320, 322, 324. The top 310 may be shaped and sized to be placed and secured in a drill chuck. The middle 312, 318 may have a circular cross section with a diameter matched to a guide hole in a surgical guide such as any of the guides described above. The drills 302, 304, 306, 308 may have a bottom surface 316, 338 proximal to the bottom 314, 320, 322, 324 that serves as a drill stop to limit drilling depth. The bottom 314, 320, 322, 324 of each drill 302, 304, 306, 308 may extend from the middle 312, 318 to an end and have a circular cross section with a diameter smaller than the diameter of the middle 312, 318 and a length from the middle 312 to the end selected according to a hole depth. The bottom 314, 320, 322, 324 may include one or more cutting surfaces 330, 332, 334, 336, which may generally include bottom and/or side surfaces for cutting as found, e.g., in conventional drills such as surgical drills. In general each middle may includes an opening in a bottom surface thereof such as a hole, keyed hole, grooved hole, or slot that removably and replaceably receives one of the drills in a secure rotational engagement relative to the middle and/or top. In this manner, drills may be removed from and replaced to the middles in order to achieve variable length and/or depth relative to the bottom drill stop portions of the middle.

The bottom 320, 322 of drills 304, 306 may have a depth guide 326, 328 to provide a visible indicator of drill depth. The depth guide 326, 328 may include a visible mark at a predetermined location on an exterior of the drill 304, 306. The depth guide may include a laser line etched on an exterior of the drill 304, 306 or any other suitable marking, symbol, or the like.

The drills 302, 304, 306, 308 may have built in drill stops at a junction between the middle 312, 318 and the bottom 314, 320, 322, 324, which may be formed for example by a shelf or overhang formed by a bottom surface of the middle 312, 318 where a diameter of the middle 312, 318 exceeds a diameter of the bottom 314, 320, 322, 324.

As an example, a drill guide hole for use with the kit 300 may be greater than 4.2 mm. Drills 302, 304, 306, and 308 may each be 37 mm in total length (i.e., the length of the top, middle, and bottom). The diameter of the middle of each drill may be 4.2 mm (or substantially 4.2 mm, such that the drill 302, 304, 306, 308 can pass through the drill guide hole). The upper sections or tops 310 of each drill 302, 304, 306, and 308 may have a length of 13 mm. The middle 312 of drill 302 may have a length of 19 mm. The middle 318 of drills 304, 306, and 308 may be 11 mm. The length of the cutting portion or bottom 314 of drill 302 may be 6 mm. The bottoms 320, 322, and 324 may have a length of 13 mm. The diameter of the bottoms 314, 320 may be 2.0 mm. The diameter of bottom 322 may be 3.0 mm, and the diameter of bottom 324 may be 4.0 mm. More generally, the drills may have varying length and varying outside diameters of the top, middle and bottom portions according a particular drilling procedure contemplated by a surgeon or other user.

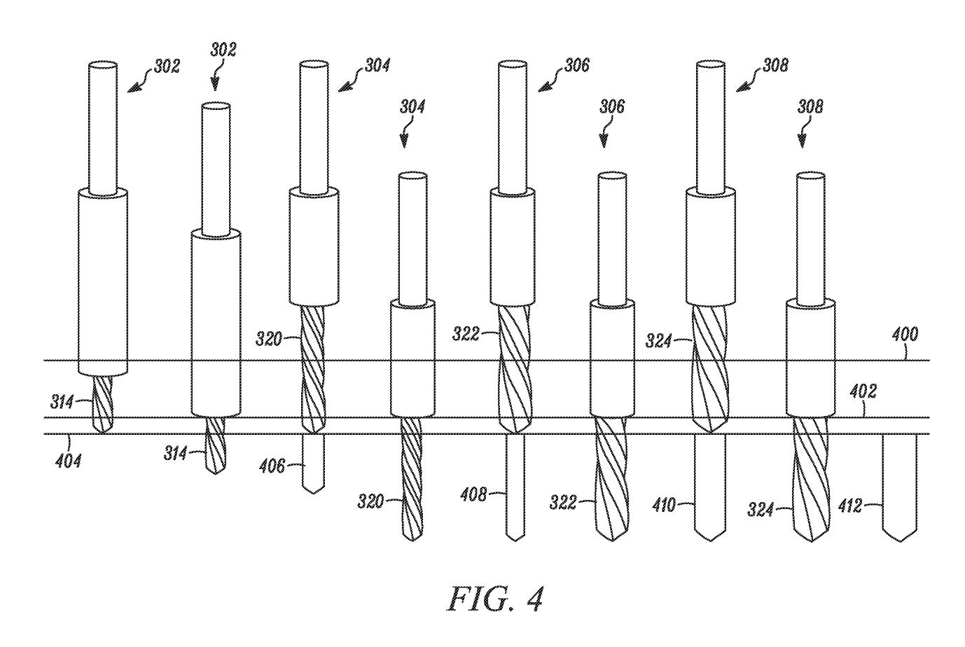

FIG. 4 shows a set of four drills 302, 304, 306, 308 such as implant drills in use with a thin layer guide. A cross-sectional view of a layer 400 of a guide (including a hole for insertion of a drill), the gum 402, and the bone 404 of a patient are shown. The distance between the layer 400 and the gum 402 may be 6 mm, and the depth of the gum (between the layer 400 and the bone 404) may be 2 mm. It will be understood that the eight drills depicted in FIG. 4 illustrate four drills 302, 304, 306, and 308, each in a pre-drill and a post-drill position relative to a patient's gum 402 (and the associated bone 404 and guide hole of the layer 400). Thus this figure is not intended to depict eight separate drills in eight separate positions on a jaw. Rather this figure is intended to illustrate the sequential use of four different drills 302, 304, 306, 308 at a common site (e.g., axially aligned to a single drill hole). Similarly, the layer 400, the gum 402, and the bone 404 are depicted as abstract layers to reflect relative height during a drilling operation, and these features are not intended to reflect the detailed guide and tissue structures present during a surgical drilling procedure or the like.

When used sequentially, the drills 302, 304, 306, 308 can create progressively larger holes resulting finally in a 4.0 mm diameter hole in the bone of a patient, which may have a depth of 11 mm, or any other suitable depth according to a length of the final drill. The first drill 302 may have a relatively short bottom 314 or cutting portion and may contact the gum 402 or bone 404 and engage the guide hole of the layer 400 at the same time to create a shallow pilot hole 406 (e.g., 2 mm diameter). A second drill 304 of the same diameter, but with a longer cutting portion 320, may engage the guide hole of the layer 400 at a middle portion for alignment and drill beyond the bottom of the pilot hole to create a hole 408 (e.g., a 2 mm diameter hole) to the full, desired depth. Additional drills 306, 308 with increased diameter of the cutting portions 322, 324 may be used to create progressively larger diameter holes 410, 412 (e.g., 3 mm and 4 mm diameters, respectively) at the surgical site.

The implant drills may be used, for example, with conventional tubed guides, thin layer drill guides or any other type of drill guides. The implant drills may, for example, be used with the thin-layer guides shown in FIGS. 1 and 2 or those described in U.S. patent application Ser. No. 12/816,710 filed on Jun. 16, 2010 and entitled “Surgical Guides,” incorporated by reference herein in its entirety. As a significant advantage, the drills of FIGS. 3 and 4 can be used sequentially with a single guide to drill progressively larger holes, thus removing the need for multiple drill guides or special inserts (or keys) matched to each one of a number of different-sized drills.

The bottom surface 316 of the middle 312 of the drill (and/or a drill extension) may contain a cutting surface and function as an end cutting burr. If the drill is inserted into the bone at an angle or if the surface of the bone is uneven, the end cutting feature would allow removal of a margin of interfering bone and allow the cutting portion of the drill to be inserted to full depth.

It should be noted that while FIGS. 3 and 4 show a specific number of drills, each having specific dimensions for length and diameter, numerous variations are possible without departing from the scope of this disclosure. For example, implant lengths vary, and may be 5, 8, 9, 9.5, 10, 11, 11.5, 12, 13, 14, or 15 mm (or any other suitable length), and suitable adaptations to the drills may be made according to the desired implant length. Implant diameters may similarly vary, such as within a range of 2-8 mm, and suitable adaptations to the drills may be made according to the desired implant diameter. In a typical implant preparation, implant holes are drilled at progressively increasing diameters of 2.0 mm, 3.0 mm, 4.0 mm and (a final diameter of) 5.0 mm, although other progressions and final drill sizes may also or instead be used.

In one aspect, a kit including various drills as described above in FIGS. 3 and 4 may include single-part drills, i.e., single-piece drills having the top, middle, and bottom portions described above, and formed of an integral piece of surgical steel or other suitable material. Each drill may, for example, include an upper portion shaped and sized for use with a drill chuck, a middle portion with an outer diameter sized for a drill guide (and optionally, a bottom cutting surface), and a bottom portion with cutting surfaces dimensioned to form a hole of the desired depth and diameter. As described in greater detail below, a suitable kit may also or instead include multi-part drills formed of removable and replaceable top and bottom sections. Thus the kit may, e.g., include drills of various diameters and physically separate drill extensions of various lengths (or depths or insert for corresponding drills) that may be combined for independent control of depth and/or diameter of a drilled hole. Thus, while the emphasis in FIGS. 3 and 4 is one single-part drills, advantages of the invention can also be achieved using a kit with multi-part drills having similar features. All such variations using single-part or multi-part drills are intended to fall within the scope of this disclosure.

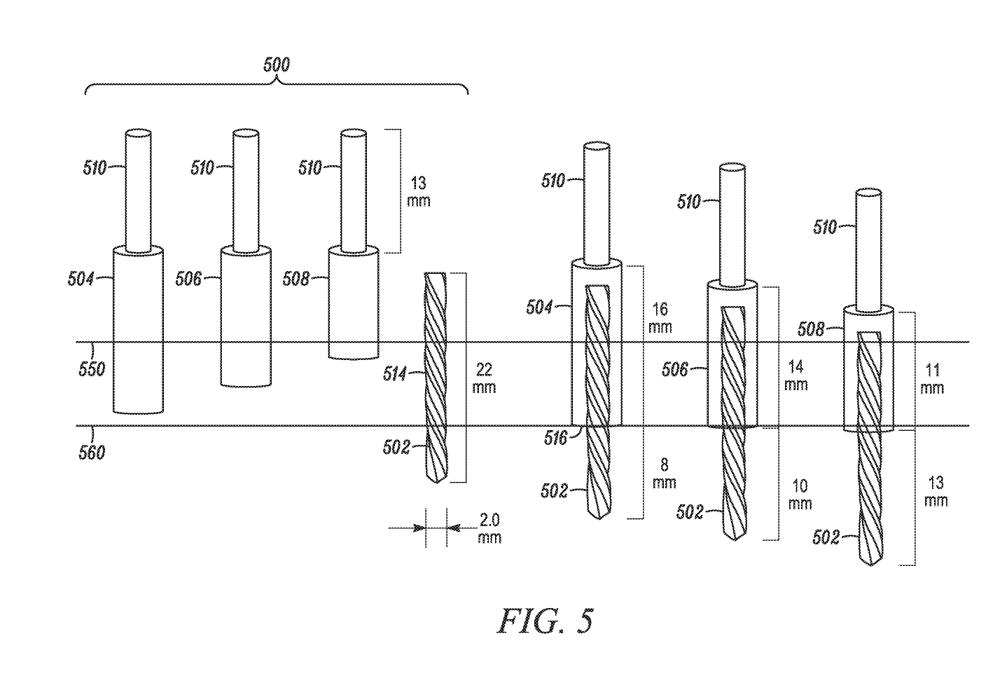

FIG. 5 shows a set of drill extensions. The set 500 may, for example be a kit including a number of drill extension 504, 506, 508—the “top and middle” portions of the single-part drills described above—along with at least one drill 502. A diameter of the drill extensions 504, 506, 508 may correspond to the diameter of a guide hole in a layer 550 of a surgical guide. The drill extensions 504, 506, 508 may each include a shaft 510, which may be sized for a drill chuck of a surgical drill or the like, and may also include an interior bore that receives a drill 502 in a rotationally secure manner (e.g., keyed to prevent rotation of the drill within the drill extension using any suitable mechanical engagement). In general, the interior bore of each drill extension 504, 506, 508 receives the drill 502 at a depth that controls a length of the drill 502 that extends from the drill extension 504, 506, 508 and beyond the drill stop 516. In this manner, a single drill 502 may be used to create holes of controlled, increasing depth by selecting progressively shorter drill extensions and/or drill extensions with progressively shallower interior bores. The interior bore may also include a magnet or any other suitable latching mechanism to releasably retain a drill 502 that has been inserted into the interior bore.

It will be noted that the term “drill” as used herein may have numerous meanings. In one aspect, the term refers to the bottom cutting portion of a multi-part drill as described above. In another aspect, the term refers to the entire multi-part drill assembly used to achieve variable hole depth and hole size. In another aspect, the term may refer to an integral or single-piece drill as described above. In another aspect, the term may refer to the hardware used to drive the multi-part drill in a rotary fashion. All such meanings are intended to fall within the scope of this disclosure, unless a specific one of these meanings is explicitly provided or otherwise clear from the context.

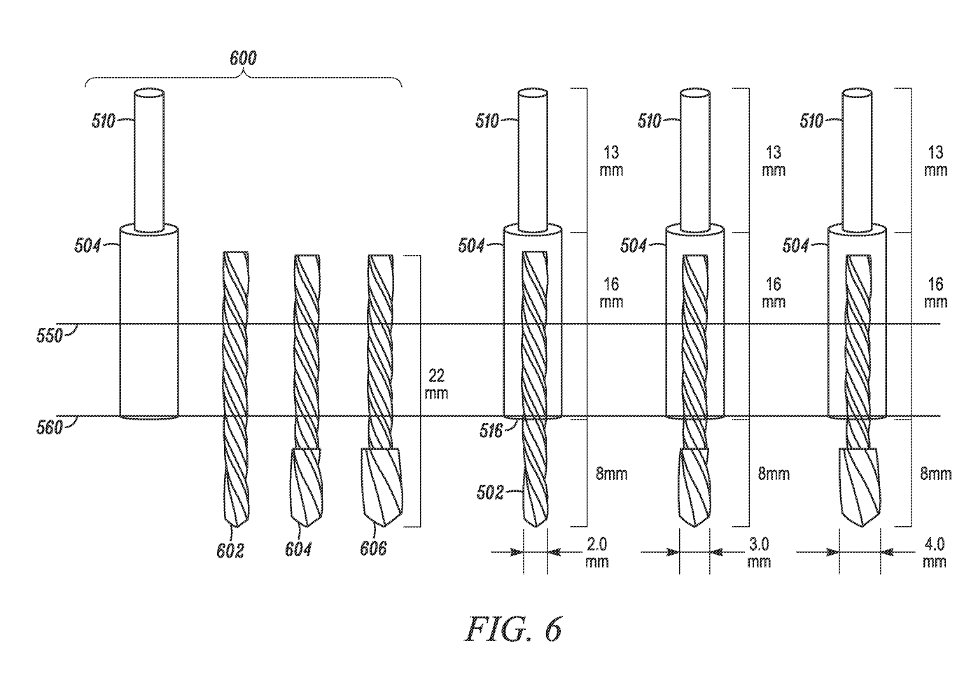

FIG. 6 illustrates a set of drills. The set 600 may, for example, be a kit including a number of drills 602, 604, 606 for the “bottom” or “cutting portions” of the single-part drills described above, along with at least one drill extension 504 for the “top” and “middle” portions described above. The series of drills 602, 604, 608 may be of equal length with varying cutting portion diameters. These drills 602, 604, 606 may be used with a single drill extension 504, which drill extension 504 may be inserted, for example, into a matched guide hole in a drill guide to create a hole for a dental implant. In one aspect, the cutting diameter of the corresponding drills 602, 604, 606 may be less than or equal to the widest exterior diameter of the drill extension 504, which among other things ensures that all such drills will fit through the matched guide hole of the drill guide layer 560. This approach may advantageously eliminate the need for multiple drill guides or special inserts (keys) corresponding to changing drill diameters.

It will be understood that a kit, as generally contemplated herein may also include multiple drill extensions such as those described in FIG. 5 for drilling to varying depths, and multiple drills for drilling to various diameters such as those depicted in FIG. 6, all without departing from the scope of this disclosure. Thus, a series of drill extensions can enforce increasing drill length (and corresponding depth of hole created), while a series of drills used therewith can provide increasing hole diameter. In one aspect, a corresponding set of drills with standard sizes (e.g., 2.0 mm, 3.0 mm, and 4.0 mm diameters) and shafts fitted to the drill extensions may be provided. The drills or drill extensions may be visually marked or encoded to indicate depth, such as with different colors for different depths. The drills may be similarly marked or color coded for diameter, thus providing a kit with drills marked or color coded for diameter and drill extensions marked or color coded for depth. The drills may be marked for depth with laser lines or the like so that a drill extension and drill combination designed to create a deep hole employing the drill stop feature can be used to create a shallower hole without employing the drill stop. There may be a laser line at the end of the drill extension or at any other suitable location.

The bottom surface 516 of the drill extension 504 may serve as a drill stop as generally described above. In addition, the bottom surface 516 may include a cutting surface or end cutting burr, so that when the device is inserted into the bone at an angle (i.e., off normal to the surface), or if the surface of the bone is uneven, the bottom surface 516 can remove a margin of interfering bone and allow the cutting portion of the drill to be inserted to full depth.

A kit as contemplated herein may include a plurality of drills with various cutting diameters and shafts 514 having equal lengths, along with cross sections keyed for rotationally secure engagement or other removable and replaceable mechanical coupling to a drill extension. The kit may also include a plurality of drill extensions each having an end 510 (or top) fitted to a drill chuck, a middle with an exterior diameter sized for a guide hole, and an interior bore 714 shaped to receive one of the plurality of drills 502 in rotationally secure engagement or other removable and replaceable mechanical coupling. The interior bore 714 of each one of the plurality of drill extensions may have a different depth. The variations in drill extension length may determine the depth of drilling. For example, the drills 502 may have the same length of 22 mm, the diameter of the hole in the layer 550 of the drill guide drill guide may be greater than 4.2 mm, and the mid-section diameter of drill extensions may be 4.2 mm. The end 510 of the drill extensions may have a length of 13 mm, the bottom may have lengths of 16 mm, 14 mm, and 11 mm, respectively, and the cutting portion of the drill 502 once inserted into the bottom may have a drilling depth into the surface 560 (e.g., bone) of 8 mm, 10 mm, and 13 mm, respectively. The length of the drill extension and drill 502 when combined (as shown in FIG. 6) may have a total length of 37 mm.

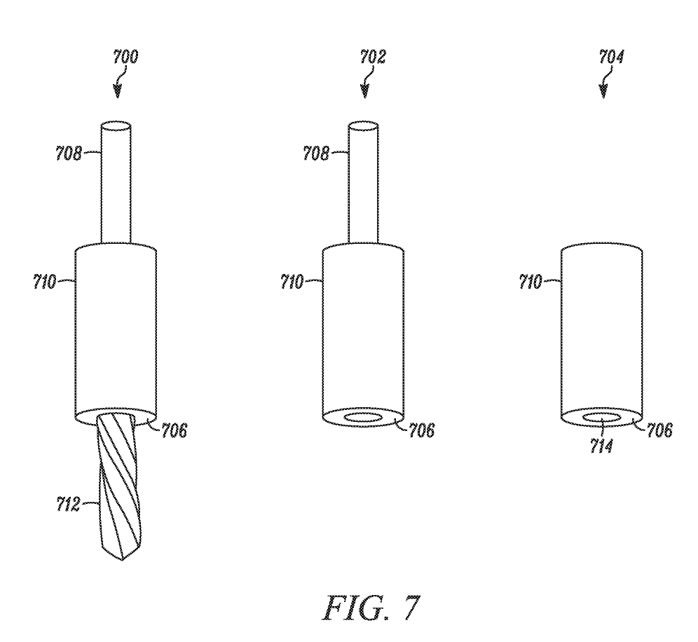

The drill extensions may have an internal chuck fitting for rotationally secure, removable, replaceable engagement of the various drills. Thus, while the interior bore 714 in FIG. 7 is depicted as a cylinder, the interior bore 714 may have any cross-section suitable for rotationally securing a drill to a drill extension for transfer or rotational force through the drill extension to the drill. A variety of suitable mechanical couplings are known in the art and may be used for removable and replaceable coupling of drills and drill extensions. A drill stop may be built in at the junction between the drill and the drill extension, or more generally formed by a shelf or the like formed between the drill extension and the drill.

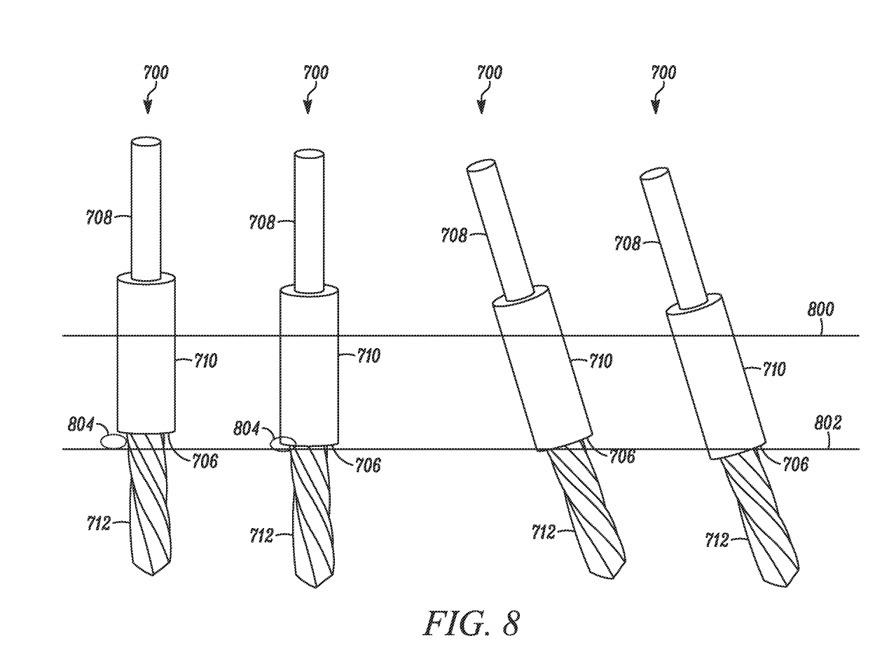

FIGS. 7 and 8 illustrate an end cutting feature of a drill 700, drill extension 702, or drill stop 704. As depicted, the end cutting feature (labeled as the bottom surface 706 of mid-portion) may include a cutting surface such as a grinding, cutting, burred, or other surface in order to remove bone and the like around irregular or angled bone contours 804. As shown in FIG. 8, the two diagrams on the left illustrate the use of the drill 700 to remove an irregular bone contour 804 or interfering bone to allow the cutting portion or bottom 704 of the drill 700 to be inserted to full depth. The two diagrams on the right illustrate the use of the drill 700 to remove a margin of interfering bone when the drill is inserted into the bone 802 at an angle. Thus in one aspect a drill disclosed herein includes an end cutting burr or similar end cutting feature. The drill stop 706 may also or instead be beveled (e.g., and 45 degrees or any other suitable amount) in order to facilitate off-angle drilling to a predetermined depth.

A hole in a layer 800 of a drill guide may have a diameter greater than 4.2 mm. The top 708 or upper section of the drill 700 may fit within a drill chuck. The mid-section or middle 710 of the drill 700 may have a diameter of 4.2 mm, or a diameter otherwise matched to the diameter of the hole in the drill guide. The drill 700 may have a drill stop 706 at the junction between the middle 710 and cutting portion 712, such as the step formed at the change in diameter.

Any of the foregoing may be provided as a kit for dental drilling. The kit may include sterile packaging for a collection of drills and/or drill extensions such as those described above, or individual components may be individually packaged in sterile packaging. Unsterilized parts may also be usefully employed where suitable sterilization facilities are available to a user. In another aspect, a case may be provided for storing the drills before and or after use with holes, clips, or the like to secure each component removably and replaceably within the case. The components may be reusable or disposable. In one aspect, the kit may provide a number of parts for a specific, predetermined drilling operation such as a dental implant drilling procedure using a single drill guide. The kit may also include a drill guide for such a procedure, which may for example, include any of the drill guides described above. The drill guide may more specifically be a drill guide shaped and sized for a specific patient, and for a specific drilling procedure for that specific patient, based upon, e.g., digital three-dimensional scanning of a drilling site or any other suitable data or model source. In another aspect, the kit may provide a number of parts for generic drilling, including, e.g. a range of drill diameters and lengths sized for use with a particular guide hole diameter, or still more generally, for a range of guide hole diameters.

While the invention has been disclosed in connection with the preferred embodiments shown and described in detail, various modifications and improvements thereon will become readily apparent to those skilled in the art. Accordingly, the spirit and scope of the present invention is not to be limited by the foregoing examples, but is to be understood in the broadest sense allowable by law.

What is claimed is:

1. A kit for use in a drilling procedure comprising a plurality of drills in a package, the kit comprising:
a first drill having a top, a middle, and a bottom, wherein the top is shaped and sized to be placed and secured in a drill chuck, the middle has a circular cross section with a diameter matched to a guide hole in a surgical guide and a bottom surface proximal to the bottom that serves as a drill stop to limit drilling depth, and the bottom extends from the middle to an end, the bottom having a second circular cross section with a second diameter smaller than the diameter of the middle and a length from the middle to the end selected according to a hole depth for the first drill, the bottom further including one or more cutting surfaces; and
a second drill having a second top, a second middle, and a second bottom, wherein the second top is shaped and sized to be placed and secured in the drill chuck, the second middle has a third circular cross section with a third diameter matched to the guide hole in the surgical guide, and the second bottom has a fourth diameter equal to the second middle and a depth guide providing a visible indicator of drill depth.

2. The kit of claim 1 wherein the bottom surface of the first drill includes an end cutting burr to remove interfering bone.

3. The kit of claim 1 further comprising a plurality of additional drills each having an additional top shaped and sized to be placed and secured in the chuck and an additional middle with a circumference matched to the guide hole, each one of the plurality of additional drills configured for a different hole diameter or a different hole depth from the first drill and the second drill.

4. The kit of claim 1 wherein the depth guide includes a visible mark at a predetermined location on an exterior of the second drill.

5. The kit of claim 1 wherein the depth guide includes a laser line etched on an exterior of the second drill.

6. The kit of claim 1 further comprising sterile packaging for each of the first drill and the second drill.

7. The kit of claim 1 wherein the drilling procedure is a surgical drilling procedure.

8. The kit of claim 1 wherein the drilling procedure is a dental drilling procedure.

9. The kit of claim 1 further comprising at least one drill guide.

10. A kit for use in a drilling procedure comprising a plurality of drills in a package, the kit comprising:
a plurality of drills having cutting portions with various cutting diameters and shafts having equal lengths and cross sections keyed for rotationally secure engagement in a corresponding hole; and
a plurality of drill extensions each having an end fitted to a drill chuck, an equal exterior diameter, and an interior bore shaped to secure each one of the plurality of drills in rotationally secure engagement, wherein the interior bore of each one of the plurality of drill extensions has a different depth.

11. The kit of claim 10 wherein the plurality of drills are color coded to identify the cutting diameter.

12. The kit of claim 10 wherein the plurality of drill extensions are color coded to identify drill depth.

13. The kit of claim 10 wherein the drilling procedure is a dental drilling procedure.

14. The kit of claim 10 wherein the drilling procedure is a surgical drilling procedure.

15. The kit of claim 10 further comprising at least one drill guide.

16. A kit for use in a drilling procedure comprising a plurality of drills in a package, the kit comprising:
a plurality of drills having equal lengths and having cutting portions with various cutting diameters, each one of the plurality of drills having a top section keyed for secure rotational engagement in a hole; and
a plurality of drill extensions each having a top and a bottom, wherein the top is shaped and sized to be placed and secured in a drill chuck and the bottom has a circular cross section with a diameter matched to a guide hole in a surgical guide, the bottom including a bottom surface proximal to the bottom that serves as an end cutting burr to remove interfering bone, each one of the plurality of drill extensions further including an interior bore shaped to secure the top section of each one of the plurality of drills in a rotationally secure engagement, wherein the interior bore of each one of the plurality of drill extensions has a different depth.

17. The kit of claim 16 wherein each one of the plurality of drills includes a visual code to identify the cutting diameter.

18. The kit of claim 17 wherein the visual code is at least one of a visible marking and a color.

19. The kit of claim 16 wherein each one of the plurality of drill extensions includes a visual code to identify drill depth.

20. The kit of claim 19 wherein the visual code includes at least one of a visible marking and a color.

21. The kit of claim 16 wherein the drilling procedure is a dental drilling procedure.

22. The kit of claim 16 wherein the drilling procedure is a surgical drilling procedure.

23. The kit of claim 16 further comprising at least one drill guide.

24. A kit for use in a drilling procedure comprising a plurality of drills in a package, the kit comprising:
a plurality of drills having cutting portions with various cutting diameters, each one of the plurality of drills having a top section keyed for secure rotational engagement in a hole; and
a plurality of drill extensions each having a top and a bottom, wherein the top is shaped and sized to be placed and secured in a drill chuck and the bottom has a circular cross section with a diameter matched to a guide hole in a surgical guide, the bottom including a bottom surface proximal to the bottom that serves as an end cutting burr to remove interfering bone, each one of the plurality of drill extensions further including an interior bore shaped to secure the top section of each one of the plurality of drills in a rotationally secure engagement,
wherein the plurality of drills and the plurality of drill extensions are configured for drilling to various predetermined depths using at least one of a different depth for one or more or the plurality of drill extensions or a different length for one or more of the plurality of drills.
